(19) United States
(12) Patent Application Publication
(10) Pub. No.: US 2007/0059122 A1
(43) Pub. Date: Mar. 15, 2007

(54) Screw for composite board

(75) Inventor: Chao-Wei Lin, Tainan City (TW)

Correspondence Address: NIXON & VANDERHYE, PC, 901 NORTH GLEBE ROAD, 11TH FLOOR, ARLINGTON, VA, 22203, US

(73) Assignee: KWANTEX RESEARCH INC., Tainan Hsien (TW)

(21) Appl. No.: 11/221,919

(22) Filed: Sep. 9, 2005

(51) Int. Cl. F16B 35/04

(52) U.S. Cl. 411/412

(57) ABSTRACT

A screw includes a head, and a shank connected to the head. The shank includes a lower threaded section that is formed with a first thread, and an upper threaded section that is disposed adjacent to the head, and that is formed with a second thread. The second thread is in a reversed orientation relative to the first thread. The shank further includes an unthreaded section that is disposed between the upper threaded section and the lower threaded section, and that is formed with at least one pair of diametrically disposed fins, and a tip that tapers from the lower threaded section. The fins are disposed proximate to the lower threaded section and distal from the upper threaded section.

### BACKGROUND OF THE INVENTION

1. Field of the Invention

This invention relates to a screw, more particularly to a screw for composite board.

2. Description of the Related Art

Wood is a common material for use in architecture and interior design due to its unique qualities, such as smell, textural pattern, etc. However, ecological and environmental-friendly concepts are widespread nowadays, and many countries have progressively started regulating timber-felling officially. Therefore, wood is increasingly being replaced by composite board that is made from recycled products. In countries such as the United States and Canada, slightly elastic composite board is made by first grinding and then thermal-treating and pressure-treating plastic combined with wood from recycled products. Since composite board does not have the fiber structure of wood, materials displaced by a screw during installation tend to move up along the shank of the screw, thereby resulting in an irregular raised bump on the board surface, which is commonly referred to as a “volcano,” or even cracks on edges of the board around where the screw is installed. The “volcano” and cracks greatly affect the finished appearance and structural safety of the composite board. Although manufacturers have come up with various solutions to this problem, there are still several shortcomings in these solutions, which will be described herebelow.

As shown in FIG. 1, U.S. Pat. No. 6,616,391 discloses a first conventional screw 1 that includes a head 11 and a shank 12. The shank 12 includes a boring portion 13, an unthreaded shank portion 14, and a threaded shank portion 15 having a thread diameter (d) and a root diameter (e) The boring portion 13 is formed with a plurality of helical flutes 131, which are in a reversed helical configuration and which have an outer diameter (f) not greater than the thread diameter (d).

As the first conventional screw 1 is driven, the boring portion 13 opens a hole in the composite board with a diameter equal to the outer diameter (f) of the helical flutes 131. Furthermore, the boring portion 13 is not proximate to the threaded shank portion 15, but is actually spaced apart from the threaded shank portion 15 by the unthreaded shank portion 14. Therefore, the space available for storing composite board materials displaced by the threaded shank portion 15 and unthreaded shank portion 14 is defined within a section of the hole that is disposed above the boring portion 13 and below the head 11, and that is not occupied by the first conventional screw 1. This space is very limited and therefore, the composite board is still vulnerable to the formation of a “volcano” and/or cracks on edges of the board around where the screw is installed.

As shown in FIG. 2, U.S. Pat. No. 6,666,638 discloses a second conventional screw 2 that includes a head 21 and a shank 22. The shank 22 includes a first threaded section 23 having a first thread diameter (g1) and a first pitch (h1), and a second threaded section 25 having a second thread diameter (g2) and a second pitch (h2), where the second thread diameter (g2) is slightly greater than the first thread diameter (g1), and the orientations of the first threaded section 23 and the second threaded section 25 are the same. The shank 22 further includes an unthreaded section 24 having a shank diameter (m) and disposed between the first threaded section 23 and the second threaded section 25.

When the second conventional screw 2 is driven, the second threaded section 25 opens a hole in the composite board having a diameter equal to the second thread diameter (g2), and opposes the composite board materials displaced by the first threaded section 23 from moving up along the shank 22. The displaced materials are thus confined in the hole that surrounds the unthreaded section 24. Taking into account the size of the second conventional screw 2 and the size of the hole that surrounds the unthreaded section 24, if the second conventional screw 2 is to be completely driven into the composite board, there would not be enough space for storing all of the displaced materials, so that the second conventional screw 2 is still incapable of suppressing the formation of a “volcano” on the surface of the board or cracks on edges of the board around where the screw is installed.

### SUMMARY OF THE INVENTION

Therefore, the object of the present invention is to provide a screw for use in a composite board that is capable of forming a space sufficient for storing composite board materials displaced by the screw, and that can prevent the formation of a “volcano” on the surface of the board and/or cracks, in order to maintain a neat finished appearance and a safe structure for the composite board.

According to the present invention, there is provided a screw that comprises: a head having a head diameter; and a shank connected to the head. The shank includes a lower threaded section that is formed with a first thread having a first thread diameter, and an upper threaded section that is disposed adjacent to the head, and that is formed with a second thread. The second thread is in a reversed orientation relative to the first thread, and has a second thread diameter. The shank further includes an unthreaded section that is disposed between the lower threaded section and the upper threaded section, and that is formed with at least one pair of diametrically disposed fins, and a tip that tapers from the lower threaded section. The fins are disposed proximate to the lower threaded section and distal from the upper threaded section. The fins have outward edges, respectively. The outward edges define a fin diameter. The fin diameter is smaller than the head diameter and larger than the first thread diameter.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a side view of a first conventional screw according to U.S. Pat. No. 6,616,391;

FIG. 2 is a side view of a second conventional screw according to U.S. Pat. No. 6,666,638;

FIG. 3 is a perspective view of the preferred embodiment of a screw according to the present invention;

FIG. 4 is a side view of the preferred embodiment, illustrating the screw when half driven into a composite board; and

FIG. 5 is a side view of the preferred embodiment, illustrating the screw when completely driven into the composite board.

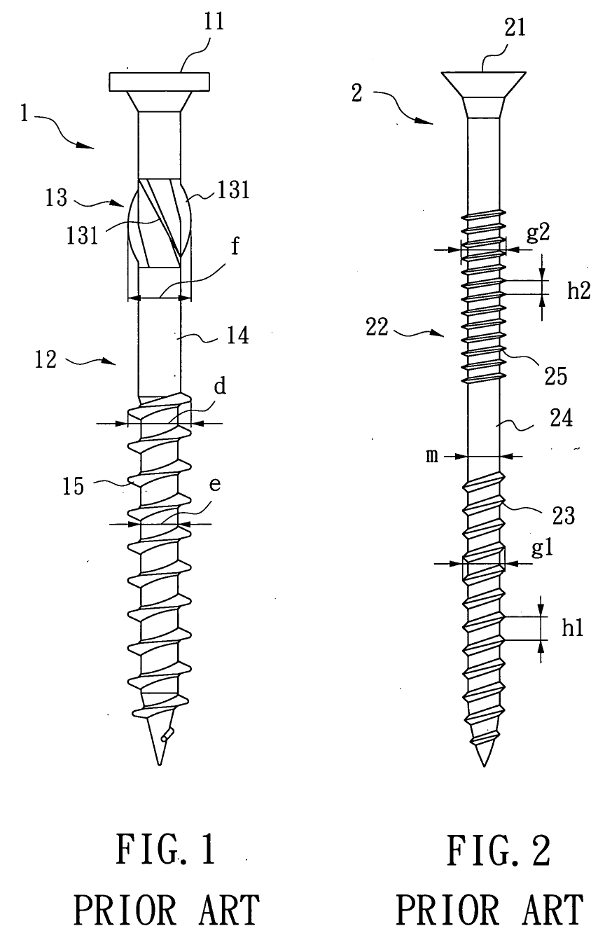

### DETAILED DESCRIPTION OF THE PREFERRED EMBODIMENT

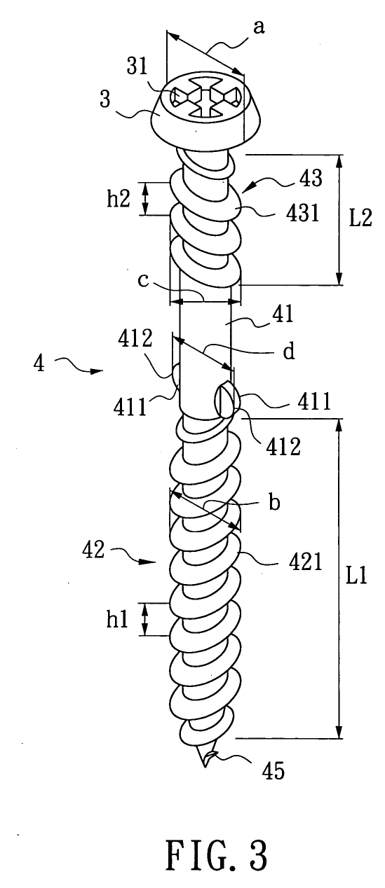

As shown in FIG. 3, the preferred embodiment of a screw according to the present invention includes a head 3, and a shank 4 connected to the head 3.

The head 3 has a head diameter (a), and a bit-receiving recess 31 that can be of any shape, such as the standard Phillips, Robertson, Torx, and Hex, or the shape as illustrated in FIG. 3 for this preferred embodiment, etc. However, the actual shape of the bit-receiving recess 31 is not a feature of this invention, so it should not limit the scope of this invention.

The shank 4 includes a lower threaded section 42, an upper threaded section 43 that is disposed adjacent to the head 3, an unthreaded section 41 that is disposed between the lower threaded section 42 and the upper threaded section 43, and a tip 45 that tapers from the lower threaded section 42. The lower threaded section 42 has a first length (L1), and is formed with a first thread 421 having a first thread diameter (b) smaller than the head diameter (a). The upper threaded section 43 has a second length (L2) smaller than the first length (L1), and is formed with a second thread 431 that is in a reversed orientation relative to the first thread 421, and that has a second thread diameter (c) smaller than the head diameter (a). Furthermore, the lower threaded section 42 has a first pitch (h1), while the upper threaded section 43 has a second pitch (h2). Equality between the first pitch (h1) and the second pitch (h2) is not essential to this invention. The unthreaded section 41 is formed with a pair of diametrically disposed fins 411 that are disposed proximate to the lower threaded section 42 and distal from the upper threaded section 43, and that have outward edges 412, respectively. A fin diameter (d) is defined by the outward edges 412, and is smaller than the head diameter (a) and larger than the first thread diameter (b). In the preferred embodiment, the fins 411 are proximate to the lower threaded section 42. However, the fins 411 can also be disposed to abut against the lower threaded section 42.

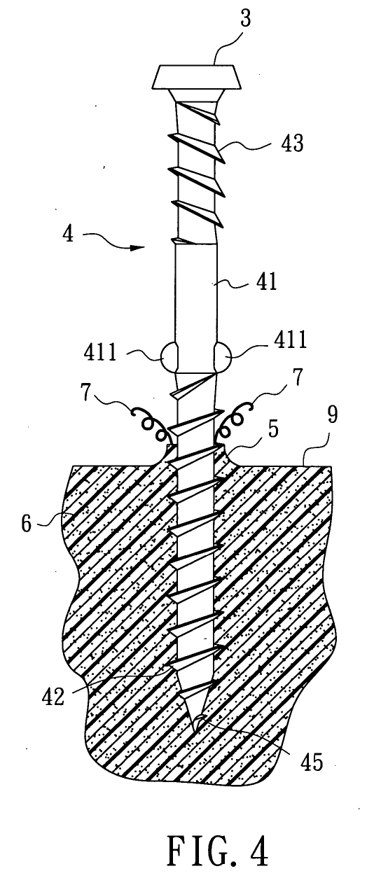

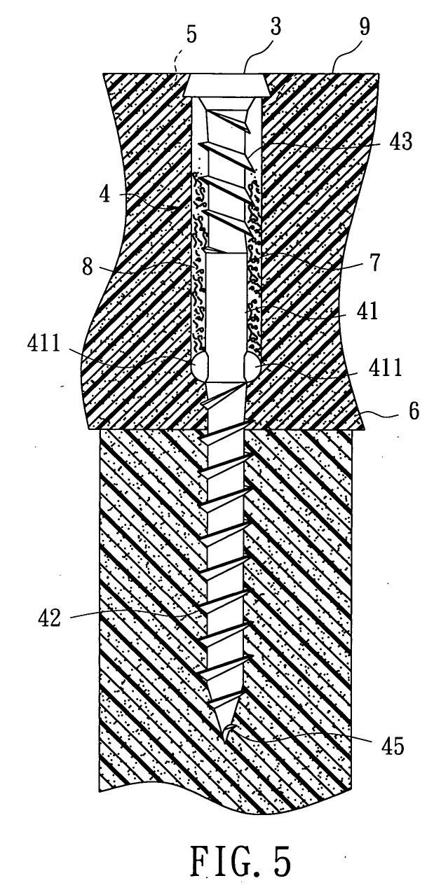

As shown in FIG. 4 and FIG. 5, the tip 45 of the shank 4 locates the screw on a composite board 6, and then guides the lower threaded section 42 into the composite board 6. As the lower threaded section 42 is driven into the composite board 6, the composite board 6 is cut and extruded, producing remnants 7 (see FIG. 4), which are essentially composite board materials displaced by the screw. The remnants 7 are forced out of the composite board 6 by the rotation of the first thread 421 of the lower threaded section 42, and a “volcano” 5 is formed on the surface 9 of the composite board 6 at the location where the screw is half driven.

As the fins 411 of the unthreaded section 41 begin to be driven into the composite material 6, a hole having a diameter equal to the fin diameter (d), which is greater than the first diameter (b), is produced by the rotation of the fins 411, thus creating a storage space 8 (see FIG. 5) for the remnants 7 in apart of the hole that is not occupied by the screw.

As the upper threaded section 43 begins to be driven into the storage space 8, the second thread 431 shoves the remnants 7 produced by the rotation of the first thread 421 and the fins 411 into the storage space 8, while the head 3 pushes the “volcano” 5 formed on the surface 9 of the composite board 6 into the storage space 8, such that the surface 9 is kept smooth after the screw has been completely driven into the composite board 6.

Since the fins 411 are disposed proximate to the lower threaded section 42 and distal from the upper threaded section 43, the storage space 8 is sufficient for storing the remnants 7 produced by the rotation of the lower threaded section 42 and the fins 411. Therefore, formation of a “volcano” 5 and/or cracks on edges of the board around where the screw is installed can be prevented, thereby maintaining a neat finished appearance and a safe structure for the composite board 6.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A screw comprising:
a head having a head diameter; and
a shank connected to said head;
said shank including:
a lower threaded section that is formed with a first thread which is a right hand thread having a first thread diameter;
an upper threaded section that is disposed adjacent to said head, and that is formed with a second thread, said second thread being in a reversed orientation relative to said first thread and having a second thread diameter;
an unthreaded section that is disposed between said lower threaded section and said upper threaded section, and that is formed with at least one pair of diametrically disposed fins; and
a tip tapered from said lower threaded section, said fins being disposed proximate to said lower threaded section and distal from said upper threaded section;
said fins having outward edges respectively, said outward edges defining a fin diameter, said fin diameter being smaller than said head diameter and larger than said first thread diameter.
